(19) United States
(12) Patent Application Publication
(10) Pub. No.: US 2008/0212714 A1
(43) Pub. Date: Sep. 4, 2008

(54) Spatial multiplexing architecture with finite rate feedback

(75) Inventors: Mahesh K. Varanasi, Boulder, CO (US); Yi Jiang, San Diego, CA (US)

Correspondence Address: LATHROP & GAGE LC, 4845 PEARL EAST CIRCLE, SUITE 300, BOULDER, CO, 80301, US

(73) Assignee: ThinkVillage LLC, Boulder, CO (US)

(21) Appl. No.: 11/893,636

(22) Filed: Aug. 17, 2007

Related U.S. Application Data
(60) Provisional application No. 60/956,373, filed on Aug. 16, 2007.
(60) Provisional application No. 60/822,677, filed on Aug. 17, 2006.

(51) Int. Cl. H04L 27/00

(52) U.S. Cl. 375/299

(57) ABSTRACT

A spatial multiplexing architecture is described for a MIMO communications system wherein the receiver feeds a number of bits of channel state information back to the transmitter. The architecture includes jointly designed ordered detection at the receiver and rate/power allocation at the transmitter. The receiver feeds back a finite number of bits to the transmitter regarding the detection order. The transmitter utilizes this detection order information to assign rates and powers. A Greedy ordering Rate Tailored (GRT-SMA) scheme is described which includes independent coding/decoding on each layer.

This application claims priority to U.S. Provisional Application No. 60/822,677, filed Aug. 17, 2006 and U.S. Provisional Application No. 60/956,373, filed Aug. 16, 2007, both incorporated herein by reference for disclosure purposes.

### STATEMENT AS TO RIGHTS TO INVENTIONS MADE UNDER FEDERALLY SPONSORED RESEARCH AND DEVELOPMENT

This Government has rights in this invention pursuant to NSF grants CCF-0423842 and CCF-0434410.

### COPYRIGHT STATEMENT

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

### BACKGROUND OF THE INVENTION

In the past decade, a significant breakthrough in wireless communication research has been the emergence and development of multiple-antenna (or multi-input multi-output (MIMO)) technologies. MIMO wireless communication systems can achieve faster data transmission with higher reliability compared to the conventional single-antenna wireless systems. MIMO block fading channels have certain advantages over their single-input single-output (“SISO”) counterparts. Specifically, such advantages may include significantly higher spectral efficiency and an improved diversity gain. MIMO technologies will play a pivotal role in the next-generation wireless systems, as the standardization of MIMO technologies into IEEE 802.11n (for Wireless LAN, or Wi-Fi) and IEEE 802.16e (for Wireless MAN, or Wi-Max) is currently under way.

Among existing MIMO technologies, space-time codes (STC's) may provide reliable communications, but they are computationally infeasible for high data rates. On the other hand, existing spatial-multiplexing methods, of which an archetypal example is the so-called Bell-labs LAyered Space Time (BLAST) architecture, can support high rate data transmission with simple implementations, but may suffer from poor reliability. Some improved SMA's have been proposed since the invention of BLAST in 1998. These architectures do have performance improvement compared to BLAST, but are significantly inferior to the theoretical performance limit.

The V-BLAST architecture is a scheme that can reap high spectral efficiency of MIMO channels. However, a standard V-BLAST scheme with equal rate and power per antenna and a fixed order of detection may suffer from error propagation problems; the antenna detected first may limit performance. In a Rayleigh fading channel with Mₜ transmit antennas and Mᵣ receive antennas (Mᵣ≧Mₜ), the diversity order of the standard V-BLAST is only Mᵣ−Mₜ+1.

To solve these problems, certain systems prescribing ordered detection at the receiver have been proposed. However, these may not yield an improvement in diversity order. Other suggested ordering schemes directed at minimizing overall error probability have yielded only limited improvements in error probability. In other proposed schemes, the symbols of the various transmit antennas are detected in a predetermined fixed order, but the rates and powers may be modified at the transmitter side across the transmit antennas by lessening the error probability of the zero-forcing decision feedback detector given constraints on total rate and total power at a given SNR. Such a strategy may yield an improvement in diversity order because with increasing SNR for a fixed total rate, the optimum transmit powers and rates are such that no rate or power is assigned to an increasing number of transmit antennas. However, this scheme may only have minor improvement in error probability.

With independent coding/decoding for each multiplexed data substream, the MIMO system may be considered equivalent to a multiple access channel (MAC), where the transmitters cannot cooperate. For a fading MAC channel, there is a fundamental tradeoff between diversity gain and multiplexing gain. Assuming no cooperation between the transmitter and the receiver, there may be a significant performance limits.

### BRIEF SUMMARY OF THE INVENTION

A novel spatial multiplexing architecture is described for a MIMO communications system wherein the receiver feeds a number of bits of channel state information back to the transmitter. Various embodiments of the invention recite novel forms of cooperation between the transmitter and receiver, comprising jointly designed ordered detection at the receiver and rate/power allocation at the transmitter. The receiver feeds back a finite number of bits to the transmitter regarding the detection order. The transmitter utilizes this detection order information to assign rates and powers. A Greedy ordering Rate Tailored Spatial Multiplexing Architecture (GRT-SMA) scheme is described which includes independent coding/decoding on each layer.

### BRIEF DESCRIPTION OF THE DRAWINGS

A further understanding of the nature and advantages of the present invention may be realized by reference to the following drawings. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1. is a graph illustrating certain bit error rates (“BERs”) in a 4×4 Rayleigh channel as functions of input SNR.

FIG. 2. is a graph illustrating certain bit error rates (“BERs”) as functions of input SNR of the layers yielded by the Norm QR decomposition.

FIG. 3. is a graph illustrating certain bit error rates (“BERs”) as functions of input SNR of the layers yielded by the Greedy QR decomposition.

FIG. 4 shows one exemplary embodiment of a MIMO communication system formed with two transceivers configured to provide bidirectional wireless communication.

FIG. 5 is a flowchart illustrating one exemplary method for controlling rate and power of data transmitted from a plurality of transmit channels of a transmitter based upon feedback information from a receiver.

FIG. 6 is a block diagram illustrating one exemplary transmitter that uses a power/rate table to determine rate settings for encoder/modulators and power settings for power amplifiers for each of a plurality of transmit channels.

FIG. 7 shows one exemplary receiver with a plurality of receive channels, antennae, a channel estimator, an ordered V-BLAST decoder and a decoding order computer.

### DETAILED DESCRIPTION OF THE INVENTION

This description provides exemplary embodiments only, and is not intended to limit the scope, applicability or configuration of the invention. Rather, the ensuing description of the embodiments will provide those skilled in the art with an enabling description for implementing embodiments of the invention. Various changes may be made in the function and arrangement of elements without departing from the spirit and scope of the invention as set forth in the appended claims.

Thus, various embodiments may omit, substitute, or add various procedures or components as appropriate. For instance, it should be appreciated that in alternative embodiments, the methods may be performed in an order different than that described, and that various steps may be added, omitted or combined. Also, features described with respect to certain embodiments may be combined in various other embodiments. Different aspects and elements of the embodiments may be combined in a similar manner.

It should also be appreciated that the following systems, methods, and software may be a component of a larger system, wherein other procedures may take precedence over or otherwise modify their application. Also, a number of steps may be required before, after, or concurrently with the following embodiments.

Various embodiments of the invention comprise a spatial multiplexing architecture (hereinafter, the “architecture”) that includes novel forms of cooperation between the transmitter and receiver. The architecture may feature “greedily” ordered detection at the receiver, and optimal rate/power allocation at the transmitter. A receiver feeds back a finite number of bits (e.g., =log₂(Mₜ!)) to the transmitter regarding the order in which the symbols would be detected. Since the receiver has “Channel State Information” (“CSI”), this order may be channel realization dependent. The transmitter may exploit this detection order information to assign optimized rates/powers, as illustrated below.

The results illustrated herein are for the most part based on the single-carrier system in a flat fading channel, as a flat fading channel simplifies the system design and performance analysis and hence provides valuable insights. However the invention is applicable to multi-carrier OFDM systems, such as Wi-Fi and Wi-Max systems. In multi-carrier systems, the frequency dimension, in addition to the spatial dimension, may be addressed. Adding the frequency dimension provides many more degrees of freedom companioned by the following two issues.

The first issue to consider is the overhead of feedback bits, which may increase linearly with the number of sub-carriers. Assume Mₜ is the number of the transmit antennas. For each sub-carrier, the standard architecture may, for example, call for (=log₂(Mₜ!)) bits feedback. If N is the number of sub-carriers, one needs a total of N*log₂(Mₜ!) bits feedback if a naive method of independent feedback is used at each sub-carrier. For example, the IEEE 802.11 (a, g, n) wireless LAN standard adopts OFDM with N=64 sub-carriers. In a system with Mₜ=4 transmit antennas, the required feedback using the naive method is 64*4.585=293.4 bits, which is a considerable overhead.

In response to this first issue, feedback reduction may be achieved by exploiting channel fading correlation across the sub-carriers, as shown in the art in various alternative contexts. Exploiting channel fading correlation can substantially reduce the feedback Because the adjacent frequency carriers are highly correlated, the associated detection orderings are likely to be very similar. For example, a Δ-modulation algorithm for feedback reduction may be applied. Since the feedback is detection ordering (which is quite insensitive to channel fluctuation), the feedback reduction may in certain contexts be very significant. Furthermore, doubly selective channels, where the channel fading is correlated in both frequency and temporal domains, may also be utilized.

The second issue to consider is the frequency diversity gain available in addition to the spatial diversity gain. The added frequency diversity gain is an advantage over the single-carrier system in flat fading channels. An optimum approach may, therefore, be to exploit frequency diversity, as well spatial diversity gain. On this issue, the architecture may be applied to each sub-carrier independently. Using error control coding across the sub-carriers, the frequency diversity can be effectively collected.

The architecture may, therefore, also be combined with error control coding. Advanced error control coding schemes, such as BICM code and Turbo Codes, may be integrated in various embodiments. The architecture may also be combined with the Automatic Retransmission reQuest (ARQ) protocol. Since some embodiments already have optimal maximal diversity gain performance, combined with ARQ the architecture can may achieve full diversity gain and full multiplexing gain simultaneously. As evident to those skilled in the art, various modification to the power/rate allocation algorithm at the transmitter may be made for such a combination.

As introduced above, some embodiments of the invention provide ordering rules and methods for allocating rates/powers to the antennas. Allocation methods may include a per layer error analysis according to a minimax optimality criterion. Ordering rules may comprise rules which may be referred to hereinafter as Norm Ordering and Greedy Ordering. According to a Norm Ordering rule, the layers may be detected in the increasing order of their respective channel column norms (i.e., the transmit antenna with the least channel column norm is detected first). The Greedy Ordering rule corresponds to detect last the layer whose column norm is the largest (as in the first ordering rule) but the second last to first detected layers may be determined through a sequence of recursively defined Householder transformations. The rate tailored SMAs based on the two orderings are referred to hereinafter as Norm ordering Rate Tailored-SMA (NRT-SMA) and Greedy ordering Rate Tailored-SMA (GRT-SMA), respectively. Certain embodiments of the invention may include alternative ordering schemes, as well.

The performances of NRT-SMA and GRT-SMA are analyzed below in the framework of D-M gain tradeoff. Diversity gain of MᵣMₜ is examined. Notably, the D-M tradeoff curve of the GRT-SMA is quite close to the optimal one.

1. Channel Model and ZF-V-BLAST

Consider a communication system with Mₜ transmit and Mᵣ receive antennas in a frequency flat fading channel. The sampled baseband signal is given by

$$y = {HW}^{\frac{1}{2}} s + z , \qquad Eq . 1$$

where sεC^{M}^{ₜ}^{×1} is the information symbols, W is a diagonal matrix with diagonal entries {wᵢ}ᵢ₌₁^{M}^{ₜ} denoting the power allocated on the ith layer, and yεC^{M}^{ᵣ}^{×1} is the received signal and HεC^{M}^{ᵣ}^{×M}^{ₜ} is the i.i.d. Rayleigh flat fading channel matrix. Assume z˜N(0,σ_{z}²I_{M}_{ᵣ}) is the circularly symmetric complex Gaussian noise where I_{Mr} denotes the identity matrix with dimension Mᵣ. Without loss of generality, s is normalized such that E[s*s]=1, and

$$W = {\sum }_{i = 1}^{{M}_{1}} {w}_{i}$$

is defined to be the total input power. Here E[•] is the expected value, and (•)* is the conjugate transpose. The overall input SNR is defined as

$$ρ = \frac{W}{{σ}_{z}^{2}} , \qquad Eq . 2$$

and the input SNR at each antenna is

$${ρ}_{i} = \frac{{w}_{i}}{{σ}_{z}^{2}} , i = 1 , 2 , ... , {M}_{1} . \qquad Eq . 3$$

For purposes of analysis, the V-BLAST scheme is equivalent to a successive interference nulling and decision feedback equalizer. In the successive interference nulling step, the V-BLAST may suppress the interference by the minimum mean-squared-error (MMSE) or zero-forcing (ZF) criterion. The latter is referred to herein as ZF-V-BLAST. The ZF-V-BLAST may be concisely represented by the QR decomposition H=QR, where R is an Mₜ×Mₜ upper triangular matrix with real-valued diagonal and Q is an Mᵣ×Mₜ matrix with its orthonormal columns being the ZF nulling vectors. Rewriting Eq. 1 as

$$y = {QRW}^{\frac{1}{2}} s + z \qquad Eq . 4$$

Left multiplying Q^{C} to the both sides of Eq. 4, which is effectively the nulling step, yields

$$\tilde{y} = {RW}^{\frac{1}{2}} s + \tilde{z} \qquad Eq . 5$$

The sequential signal detection, which involves the decision feedback, is as follows:

$$for i = {M}_{t} : - 1 : 1$$

$$\hat{{s}_{i}} = C [ ( {\overline{y}}_{i} - {\sum }_{j = i + 1}^{{M}_{t}} {r}_{ij} \sqrt{{w}_{j}} {\hat{s}}_{j} ) / {r}_{ii} ]$$

$$end$$

where C[•] stands for mapping to the nearest point in the symbol constellation. Ignoring the error-propagation effect, notice that the MIMO channel is decomposed into Mₜ parallel layers

\tilde{y}ᵢ=rᵢᵢ\sqrt{wᵢ}sᵢ+\tilde{zᵢ}, i=1, 2, . . . , Mₜ Eq. 6

The output SNR of the ith layer is rᵢᵢ²ρᵢ. With fixed order detection, rᵢᵢ²˜X₂_{^{(M}}ᵣ_{^{−i+1)}} a Chi-square distribution. However, if a channel dependent ordering algorithm is employed, the distribution of rᵢᵢ² is much more complicated, and this issue shall be addressed later.

2. Hyperbola Model of BER-Vs-SNR Curve

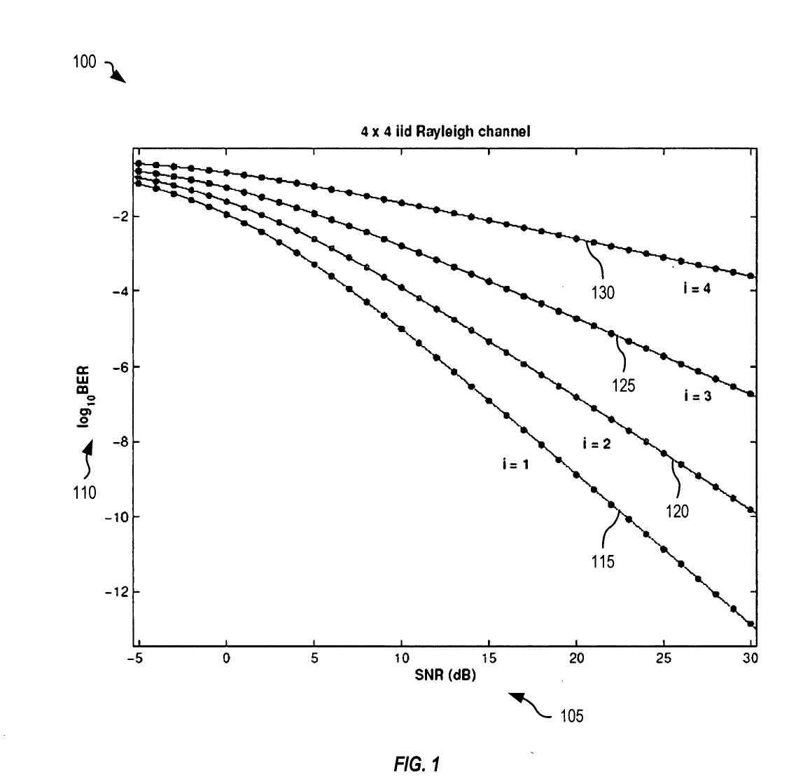

A distinction between an AWGN channel and a fading channel is their different BER performance at high SNR. With a binary phase-shift keying (BPSK) input, as the input SNR ρ→∞, the BER over the AWGN channel decreases like e^{-ρ} while over a fading channel the BER diminishes like ρ^{-D}, where D is referred to as the diversity gain of the fading channel. More formally, the channel diversity gain may be defined as:

$$D {=}^{Δ} - {lim}_{x \to ∞} \frac{log {P}_{e}}{log ρ} . \qquad Eq . 7$$

where Pₑ is the probability of error. In a high SNR regime, the logarithm of BER of a fading channel is approximately a linear function of input SNR in decibel (dB). For example, using uncoded BPSK, the ith layer with error-free decision feedback from the previously detected layers have BER

$${P}_{b , i} = {E}_{{r}_{ii}} [ {\int }_{\sqrt{2 {r}_{ii}^{2} {ρ}_{i}}}^{∞} \frac{1}{\sqrt{2 π}} exp ( - \frac{{x}^{2}}{2} ) d x ] , \qquad Eq . 8$$

where Eᵣᵢᵢ[•] stands for the expectation with respect to rᵢᵢ. FIG. 1 is a graph 100 illustrating log₁₀(Pb,i) (i.e., log₁₀ BER) of four layers as functions of input SNR (in dB) in a 4×4 Rayleigh channel. The BERs 110 are plotted as functions of input SNR 105 of the four layers of unordered ZF-V-BLAST. The channel is of 4×4 i.i.d. Rayleigh fading with BPSK input. The dots “•” are plotted according to Eq. 8, and the solid lines for each of the 4 layers (115, 120, 125, 130) are the fitting hyperbolas based on Eq. 10, below.

The BER expressions over fading channels are often complicated even in the simple case of Rayleigh channel and BPSK input. A general M-QAM input makes them even more involved. For most types of fading, a closed-form BER expression simply does not exist. Thus, a simple yet effective hyperbola model is utilized herein to fit the BER-vs-SNR curves of a fading channel. This hyperbola model is used in developing the rate/power allocation scheme, discussed below.

If P_{b}(r²p, M) is the BER of a scalar channel with channel gain r, M-QAM input, and input SNR p, assume

x=10 log₁₀ ρ and y=log₁₀ Eᵣ[P_{b}(r²ρ,M)]. Eq. 9

Then x and y are the X and Y-coordinate in FIG. 1, respectively. The following hyperbola model may be used to approximate the BER-vs-SNR curve:

$$y ( x ) = \frac{d}{20} [ ( a - x ) - \sqrt{{( a - x )}^{2} + b} ] - c . \qquad Eq . 10$$

The solid lines (115, 120, 125, 130) in FIG. 1 are obtained by fitting the dots (which are computed using Eqs. 8 and 10). It can be seen that the hyperbolas fit the dots extremely well. As detailed below, this hyperbola model also may work very well for channels with more complicated fading distributions. Given the probability density function of r² and the exact expression of P_{b}(r²ρ, M), y can be calculated via numerical integration per Eq. 9.

The hyperbola of Eq. 10 has two asymptotic lines:

$$y = - c as x \to - ∞ and y = \frac{d}{10} ( a - x ) - c as x \to + ∞ \qquad Eq . 11$$

By changing a and c, the curve can be shifted in the horizontal and vertical directions, respectively. Therefore:

$${lim}_{x \to ∞} \frac{d y ( x )}{d x} = - \frac{d}{10} . \qquad Eq . 12$$

On the other hand, according to Eq. 7, the channel diversity gain is

$$D = - {lim}_{x \to ∞} \frac{log {P}_{e}}{log ρ} = - {lim}_{x \to ∞} \frac{d y ( x )}{d x / 10} . \qquad Eq . 13$$

It follows from Eqs. 12 and 13 that

d=D Eq. 14

which determines the asymptotic curve slope. The parameter b can control the curvature of the hyperbola when x is small. In other words, b affects the BER curve in the low to moderate SNR regime. Since lim_{x→∞}y(x)=log₁₀ 0.5=−0.301, according to Eq. 11 it may be presumed that the optimal c=0.301. However, it may be beneficial to keep c as an undetermined parameter since it can help reduce further the fitting error.

III. ZF-V-BLAST with Ordered Detection

As mentioned above, the ZF-V-BLAST equalizer can be represented by the QR decomposition applied to the channel matrix H. Correspondingly, an ordered ZF-V-BLAST can be represented by applying the QR decomposition to H with columns permuted. For H with Mₜ columns, one has Mₜ! options of detection orderings. In this section, two exemplary cases will be addressed namely, Norm Ordering and Greedy Ordering. The QR decompositions with Norm and Greedy Orderings may be referred to hereinafter as Norm QR and Greedy QR, respectively.

Norm OR Decomposition: The procedure of Norm QR decomposition comprises:

(i) Calculate the Euclidean norms {∥hᵢ∥}ᵢ₌₁^{M}^{ₜ}.

(ii) Find permutation matrix π such that the column norms of the new matrix Hπ, from the left to the right, are in non-increasing order.

(iii) Apply the QR decomposition Hπ=QR.

For the Norm QR decomposition, the PDFs of the layer gains {rᵢᵢ²}ᵢ₌₁^{M}^{ₜ} have been obtained, and may be summarized as follows: Assume Hπ=QR is the Norm QR decomposition of an i.i.d. Rayleigh fading channel matrix HεC^{M}^{ᵣ}^{×M}^{ₜ}. Then r₁₁² has the distribution

$${f}_{{r}_{11}^{2}} ( x ) = \frac{1}{{M}_{t}} \cdot \frac{{x}^{{M}_{r} - 1} {e}^{- x}}{( {M}_{r} - 1 ) !} {( 1 - {e}^{- x} {\sum }_{k = 0}^{{M}_{r} - 1} \frac{{x}^{k}}{k ! } )}^{{M}_{t} - 1} , x > 0 \qquad Eq . 15$$

and the other diagonal elements have PDFs

$${f}_{{r}_{ii}^{2}} ( x ) = \frac{{x}^{{M}_{r} - i} {e}^{- {M}_{t} x}}{β ( {M}_{r} - i + 1 , i - 1 ) β ( {M}_{t} + 1 - i , i ) ( {M}_{r} - 1 ) !} \times {\int }_{0}^{∞} {w}^{i - 2} {{e}^{- {M}_{t} w} ( {\sum }_{k = {M}_{t}}^{∞} \frac{{( x + w )}^{k}}{k !} )}^{{M}_{t} - i} {( {\sum }_{k = 0}^{{M}_{t } - 1} \frac{{( x + w )}^{k}}{k !} )}^{i - 1} d w , \\ x > 0 , for i = 2 , ... , {M}_{t} , where \\ β ( a , b ) = {\int }_{0}^{1} {{t}^{a - 1} ( 1 - t )}^{b - 1} d t = \frac{Γ ( a ) Γ ( b )}{Γ ( a + b )} . \qquad Eq . 16$$

Moreover,

$${lim}_{∈ \to {0}_{+}} \frac{log P ( {r}_{ii}^{2} < ∈ )}{log ∈} = \{ \begin{matrix}{M}_{t} {M}_{r} & i = 1 \\ {M}_{r} - i + 1 , & i = 2 , ... , {M}_{t}\end{matrix} \qquad Eq . 17$$

In other words, for the ZF-V-BLAST using Norm QR decomposition, the first layer has diversity gain MₜMᵣ and the ith layer (2≦i≦Mₜ) has diversity gain Mᵣ−i+1.

Given finite Mₜ and Mᵣ, the exact expression of the PDF may be obtained using any number of tools known in the art, such as Mathematica™. Having obtained the PDFs of rᵢᵢ², the BER-vs-SNR curves associated with all the Mₜ layers can be obtained via numerical integration.

Recall that the ith layer of unordered V-BLAST equalizer has diversity gain of Mᵣ−i+1, and thus Norm QR can significantly increase the diversity gain of the first layer. Unfortunately however, there is no apparent diversity gain improvement for the other layers. To further exploit the channel diversity gain, the Greedy QR decomposition may be used.

Greedy QR Decomposition: The Greedy QR decomposition consists of Mₜ−1 steps. Only the first step is set forth herein, from which the subsequent steps would be clear.

In the first step, we go through the following procedures.

(i) Calculate the Euclidean norms {∥hᵢ∥}ᵢ₌₁^{M}^{ₜ} where hᵢ is the ith column of H.
(ii) Permute h₁ and hⱼ where j=arg max_{1≦i≦M}_{ₜ} {|hᵢ∥}. This operation can be represented by H₁=Hπ₁ with π₁ being a permutation matrix. (If j=1, π₁ degrades to I_{M}_{ₜ})
(iii) Apply a Householder matrix Q₁ to transform the first column of H₁ to a scaled e₁, where e₁ is the first column of I_{M}_{ᵣ}.

The procedure (i-iii) can be illustrated as follows

$$( \begin{matrix}\times & \times & \times & \times \\ \times & \times & \times & \times \\ \times & \times & \times & \times \\ \times & \times & \times & \times \end{matrix} ) {{Q}_{1}^{*} H {Π}_{1}}_{} ( \begin{matrix}{r}_{11} & \times & \times & \times \\ 0 & \times & \times & \times \\ 0 & \times & \times & \times \\ 0 & \times & \times & \times \end{matrix} ) . \qquad Eq . 18$$

Note that r₁₁=max {∥hᵢ∥, 1≦i≦Mₜ}. In the next step, the same procedures are applied to the trailing (Mᵣ−1)×(Mₜ−1) submatrix on the right hand side of Eq. 18, which yields a permutation π₂ and a Householder matrix Q₂. After Mₜ−1 recursive steps, the Greedy QR decomposition is obtained.

Hπ=QR, Eq. 19

where π=π₁ π₂ . . . π_{M}_{ₜ} with π_{M}_{ₜ}=I and Q=Q₁ Q₂ . . . Q_{M}_{ₜ} with Q_{M}_{ₜ}=I if Mₜ=Mᵣ. In summary, at the ith step this ordering algorithm “greedily” attempts to make the ith diagonal element of R as large as possible.

Note that Norm and Greedy QR decompositions yield the same r₁₁², which has the PDF given in Eq. 15. While the distributions of {rᵢᵢ²}ᵢ₌₂^{M}^{ₜ} appear intractable, the BER-vs-SNR curve associated with the following layers may be obtained via Monte Carlo trials. Nevertheless, the diversity order associated with these layers may be analyzed, and indeed shows a diversity gain improvement due to Greedy Ordering.

In light of the foregoing, it may be concluded that in an i.i.d. Rayleigh fading channel HεC^{M}^{ᵣ}^{×M}^{ₜ}, the ith diagonal of R in Eq. 19 has the property

$${lim}_{∈ \to {0}_{+}} \frac{log P ( {r}_{ii}^{2} < ∈ )}{log ∈} = ( {M}_{t} - i + 1 ) ( {M}_{r} = i + 1 ) \qquad Eq . 20$$

In other words, for the ZF-V-BLAST using Greedy QR decomposition, the ith layer it may be concluded that the diversity gain Dᵢ=(Mₜ−i+1)(Mᵣ−i+1).

Numerical Examples: The BER-vs-SNR curve of each layer obtained by using Norm and Greedy QR decompositions follows. These curves are then approximated by the hyperbola model.

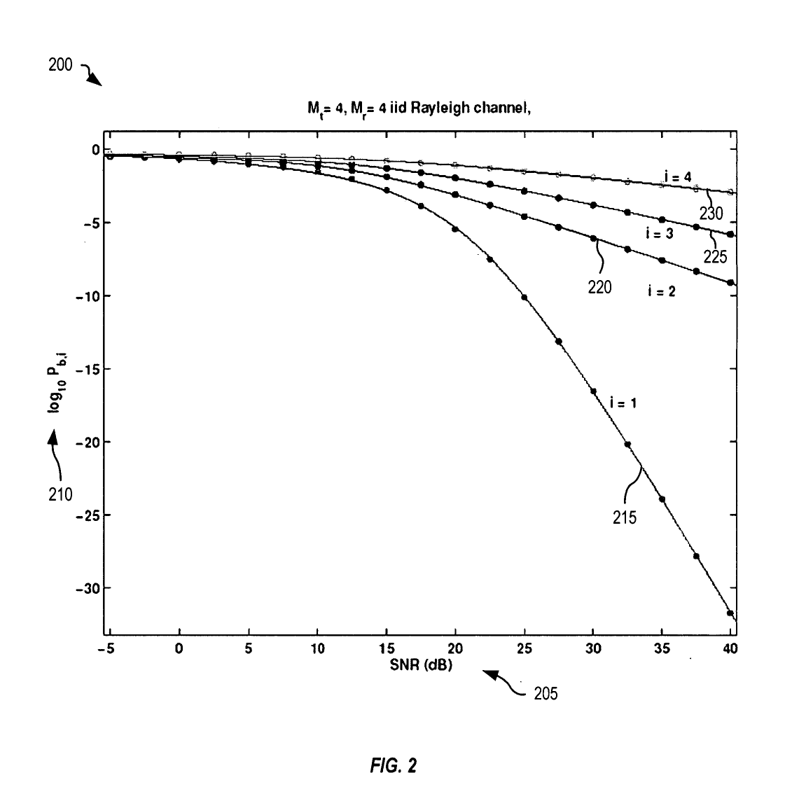

FIG. 2 is a graph illustrating an exemplary BER-vs-SNR performance (represented by dots “•”) of each layer obtained using the Norm QR decompositions. The BERs 210 are plotted as functions of input SNR 205 of the layers yielded by the Norm QR decomposition. The input is 64-QAM. The dots “•” are plotted via numerical integration. The solid lines (215, 220, 225, 230) are the fitting hyperbolas based on the model. Mₜ=4 and Mᵣ=4. In this case, the PDFs of all the rᵢᵢ²'s are known. Hence for each layer the BERs can be obtained via numerical integration.

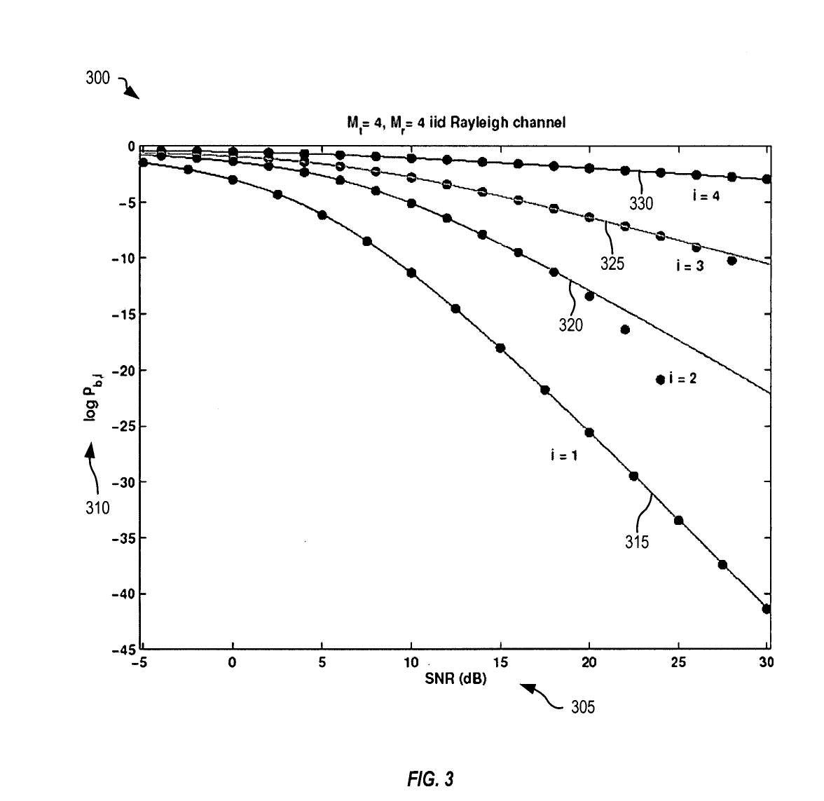

FIG. 3 is a graph illustrating an exemplary BER-vs-SNR performance of the layers yielded by the Greedy QR decompositions. The BERs 310 are plotted as functions of input SNR 305 of the layers yielded by the Greedy QR decomposition. The input is BPSK symbols. The dots “•” are plotted via numerical integration (the 1st layer) or Monte Carlo trials (the other layers). The solid lines (315, 320, 325, 330) are the fitting hyperbolas based on the model. Mₜ=Mᵣ=4. The BERs of the first layer (i=1) are obtained via numerical integration since the PDF of r₁₁² is known. Because the distributions of {rᵢᵢ²}ᵢ₌₂^{M}^{ₜ} are not known, the BERs of the ith layer (i≧2) are approximated by averaging over 10⁸ Monte Carlo trials. Note that the BER estimations based on Monte Carlo trials may not be reliable when BER is very small (e.g., less than 10⁻¹). Hence, when applying the curve fitting, those outliers are discarded in the high SNR regime. The hyperbolas fit the simulated points well when BER is larger than 10⁻¹⁰, which is the regime of practical interest.

IV. OPTIMAL RATE/POWER ALLOCATION With the hyperbola parameters, the optimal rate/power allocation algorithm may be further described. Given an overall power and rate constraint, one can minimize the system BER by optimally allocating rate and power on the layers. In this example, the candidate constellations are constrained to 4-QAM, 16-QAM, 64-QAM and 256-QAM, while in other examples the extension to other constellations may not necessarily impose any difficulty. The rate/power allocation algorithm can be applied to the V-BLAST detector with any detection ordering scheme, as long as the corresponding hyperbola parameters for each layer are available. In particular, when the rate/power allocation algorithm is applied to the V-BLAST detector with Greedy and Norm QR decompositions, the GRT-SMA and NRT-SMA schemes are obtained.

Denote P_{b,i} the BER of the ith layer with Mᵢ-QAM input and error-free decision feedback from the previously detected layers. Then

$${P}_{b , i} = {E}_{{r}_{ii}} [ {P}_{b} ( \frac{{w}_{i} {r}_{ii}^{2}}{{σ}_{z}^{2}} , {M}_{i} ) ] . \qquad Eq . 21$$

With the definitions (Eq. 9)

$${x}_{i} {=}^{Δ} 10 {log}_{10} \frac{{w}_{i}}{{σ}_{z}^{2}} , {y}_{i} {=}^{Δ} {log}_{10} {P}_{b , i} , \qquad Eq . 22$$

the BER-vs-SNR curve can be closely approximate by the model

$${y}_{i} = \frac{{d}_{i}}{20} ( {a}_{i} - {x}_{i} - \sqrt{{( {a}_{i} - {x}_{i} )}^{2} + {b}_{i}} ) - {c}_{i} . \qquad Eq . 23$$

Combining Eqs. 22 and 23 yields.

$${P}_{b , i} = {10}^{\frac{{d}_{i}}{20}} ( {a}_{i} - {x}_{i} - \sqrt{{( {a}_{i} - {x}_{i} )}^{2} + {b}_{i}} ) - {c}_{i} . \qquad Eq . 24$$

The overall BER seems to be the best performance metric for a scheme. Unfortunately, due to the error-propagation effect, the exact form of the overall BER is very complicated. In this example max {P_{b,i}: 1≦i≦K} is adopted as the performance metric to optimize, where K is the number of layers in use. The overall input power is constrained to be

$${\sum }_{i = 1}^{K} {w}_{i} = W .$$

from Eq. 22, this constraint can be rewritten as

$${\sum }_{i = 1}^{K} {10}^{\frac{{x}_{i}}{10}} = W / {σ}_{z}^{2} . \qquad Eq . 25$$

The issue of optimal rate/power allocation may be summarized as the following optimization problem:

$${min}_{{x}_{i} , {M}_{t}} {max}_{1 \leq i \leq K} \{ {10}^{\frac{{d}_{i}}{20} ( {a}_{i} - {x}_{i} - \sqrt{{( {a}_{i} - {x}_{i} )}^{2} + {b}_{i}} ) - {c}_{i}} \} \\ subject to {\sum }_{i = 1}^{K} {10}^{\frac{{x}_{i}}{10}} = W / {σ}_{z}^{2} \\ {\sum }_{i = 1}^{K} {log}_{2} {M}_{i} = R \qquad Eq . 26$$

The hyperbola parameters depend on the size of QAM. Hence Mᵢ is relevant in the cost function. Notice that the feasible set of {Mᵢ}ᵢ₌₁^{K} is finite. The solution of Eq. 26 may be decoupled into two steps.

First, a feasible constellation tuple is fixed:

$${min}_{{x}_{i}} {max}_{1 \leq i \leq K} \{ {10}^{\frac{{d}_{i}}{20} ( {a}_{i} - {x}_{i} - \sqrt{{( {a}_{i} - {x}_{i} )}^{2} + {b}_{i}} ) - {c}_{i}} \} . \\ subject to {\sum }_{i = 1}^{K} {10}^{\frac{{x}_{i}}{10}} = W / {σ}_{z}^{2} \qquad Eq . 27$$

At an optimal solution to the minimax problem, the BERs {P_{b,i}}ᵢ₌₁^{K} may be the same. Suppose an optimal solution occurs where P_{b,i}>P_{b,j} for ∀j≠i. Because the BER is a continuous function of input power, wᵢ can be increased to wᵢ+δ and wₖ (k≠i) can be reduced to wₖ−δ such that the new BER \tilde{P}_{b,k}=\tilde{P}_{b,i}<P_{b,i}. Hence the cost function max {P_{b,i}, 1≦i≦K} is reduced, which contradicts the optimality assumption. Therefore it may be concluded that P_{b,i}'s are the same at an optimal solution. Denote

$$\begin{matrix}λ {=}^{Δ} {log}_{10} {P}_{b , i} = \frac{{d}_{i}}{20} ( {a}_{i} - {x}_{i} - \sqrt{{( {a}_{i} - {x}_{i} )}^{2} + {b}_{i}} ) - {c}_{i} & ∀ i\end{matrix} \qquad Eq . 28$$

It follows that

$${x}_{i} = {a}_{i} + \frac{{b}_{i} {d}_{i}}{40 ( λ + {c}_{i} )} - \frac{10 ( λ + {c}_{i} )}{{d}_{i}} . \qquad Eq . 29$$

Substituting Eq. 29 into Eq. 25, λ may be calculated using Newton s iterative method. Consequently, xᵢ, and wᵢ are obtained.

In the second step, letting {Mᵢ}ᵢ₌₁^{K} go over the feasible set, for each constellation tuple Eq. 27 is solved. The constellation tuple {Mᵢ}ᵢ₌₁^{K} and the associated {xᵢ}ᵢ₌₁^{K} are recorded, which yield a smallest cost function.

The complicated power and rate allocation algorithm presented above may be implemented offline once, which generates a lookup table (e.g., Table 1) including the input SNR constraint and the rate/power allocation on each layer. Indeed, the online computational complexity may therefore quite small. For each channel realization, the receiver may determine the detection ordering using either Greedy or Norm ordering algorithm. Then the receiver may feed the permutation matrix π (see Eq. 19) back to the transmitter, which may be encoded by log₂(Mₜ!) bits. Based on the ordering information, the transmitter may next check the lookup table to determine the power and rates allocated on each transmit antenna. In one embodiment, therefore, compared to the standard V-BLAST, the only added complexity of NRT-SMA/GRT-SMA may be to maintain a lookup table, and a produce a small amount of feedback. For example, when Mₜ=4, only log₂(4!)=4.585 bits are fed back to the transmitter. The lookup table of GRT-SMA for a 4×4 channel with overall rate constraint R=16 is given Table 1.

In multi-carrier OFDM systems, the overhead of feedback bits may increase linearly with the number of sub-carriers. For example, for each sub-carrier the standard architecture may call for (=log₂(Mₜ!)) bits feedback. Note that feedback reduction may be achieved by exploiting channel fading correlation across the sub-carriers. Exploiting channel fading correlation can substantially reduce the feedback. Since the feedback is detection ordering (which is quite insensitive to channel fluctuation), the feedback reduction may in certain contexts be very significant.

Table 1 illustrates the power allocation for GRT-SMA (The optimal rate allocation: _{6/6/4/0} in the whole SNR range).

TABLE 1

| Layer | SNR = 14 dB | 16 dB | 18 dB | 20 dB | 22 dB | 24 dB | 26 dB | 28 dB | 30 dB |
|---|---|---|---|---|---|---|---|---|---|
| 1 | 5.6594 | 8.9944 | 14.3925 | 22.9163 | 35.7918 | 54.0829 | 78.3608 | 108.6637 | 144.7930 |
| 2 | 11.6497 | 18.6142 | 29.3691 | 45.7216 | 70.1770 | 106.0488 | 157.4286 | 229.0046 | 326.0209 |
| 3 | 7.8098 | 12.2024 | 19.3342 | 31.3621 | 52.5233 | 91.0571 | 162.3178 | 293.2890 | 529.1864 |
| 4 | 0 | 0 | 0 | 0 | 0 | 0 | 0 | 0 | 0 |

Diversity-Multiplexing Tradeoff: A scalar fading channel with diversity gain D, i=1, . . . , Mₜ may have a D-M tradeoff

D(R)=D(1−R), 0≦R≦1, Eq. 30

where R is the multiplexing gain. According to calculations above, GRT-SMA converts a MIMO channel into Mₜ layers with diversity gain Dᵢ=(Mₜ−i+1)(Mᵣ−i+1). Hence the corresponding D-M tradeoffs are

Dᵢ(R)=(Mₜ−i+1)(Mᵣ−i+1)(1−Rᵢ) i=1, . . . , Mₜ.

Similarly, NRT-SMA may yield layers with D-M tradeoffs

$${D}_{i} ( {R}_{i} ) = \{ \begin{matrix}{M}_{t} {M}_{r} ( 1 - {R}_{i} ) & i = 1 , \\ ( {M}_{r} - i + 1 ) ( 1 - {R}_{i} ) & i = 2 , … , {M}_{t} .\end{matrix}$$

In contrast, the diversity gain of the layers of the fixed order RT-VB scheme may only be

Dᵢ(Rᵢ)=(Mᵣ−i+1)(1−Rᵢ) i=1, . . . , Mₜ

The rate/power allocation algorithm discussed above attempts to make all the layers share the same BER. Hence according to Eq. 7, all the layers in use have the same diversity gain, i.e.,

$$\begin{matrix}{D}_{i} ( {R}_{i} ) = {D}_{i} ( 1 - {R}_{i} ) = D , i = 1 , … , K & Eq . 31 \\ {R}_{i} = 1 - \frac{D}{{D}_{i}} . & Eq . 32\end{matrix}$$

From the overall rate constraint

$${\sum }_{i = 1}^{K} {R}_{i} = R ,$$

the following equation may be obtained:

$$K - D {\sum }_{i = 1}^{K} {D}_{i}^{- 1} = R , \\ and hence$$

$$D = \frac{K - R}{{\sum }_{i = 1}^{K} {D}_{i}^{- 1}} .$$

A maximal achievable diversity gain is obtained by maximizing D over K, the number of transmit antennas in use. That is

$$D ( R ) = {max}_{{R < K \leq {M}_{i}}_{K ∈ Z}} \frac{K - R}{{\sum }_{i = 1}^{K} {D}_{i}^{- 1}} . \qquad Eq . 33$$

After some analysis it may be shown that the achievable D-M tradeoff function is a piecewise linear curve connecting the following Mₜ+1 points

$$( 0 , {D}_{1} ) , {\{ ( K - \frac{{\sum }_{i = 1}^{K} {D}_{i}^{- 1}}{{D}_{K + 1}^{- 1}} , {D}_{K + 1} ) \}}_{K = 1}^{{M}_{t} - 1} , and ( {M}_{t} , 0 ) .$$

In the preceding description, it has been implicitly assumed that Mᵣ≧Mₜ for the simplicity of the description. However, the NRT-SMA/GRT-SMA may be applied to the scenario where Mᵣ<Mₜ.

A novel combination of ordered detection at the receiver and rate/power allocation at the transmitter provide for much improved detection in MIMO communications. In particular, a Greedy ordering Rate Tailored SMA (GRT-SMA) scheme has been described which applies the optimal rate/power allocation in the transmitter and a greedy ordering detection at the receiver. Assuming a finite rate channel state information (CSI) feedback from the receiver to the transmitter, the GRT-SMA scheme may achieve an improved diversity-multiplexing (D-M) gain tradeoff. Because GRT-SMA admits independent scalar coding for each layer, it may also be applied to multi-user communications.

It should be noted that the methods, systems and devices discussed above are intended merely to be exemplary in nature. It must be stressed that various embodiments may omit, substitute, or add various procedures or components as appropriate. For instance, it should be appreciated that in alternative embodiments, the methods may be performed in an order different than that described, and that various steps may be added, omitted or combined. Also, features described with respect to certain embodiments may be combined in various other embodiments. Different aspects and elements of the embodiments may be combined in a similar manner. Also, it should be emphasized that technology evolves and, thus, many of the elements are exemplary in nature and should not be interpreted to limit the scope of the invention.

Specific details are given in the description to provide a thorough understanding of the embodiments. However, it will be understood by one of ordinary skill in the art that the embodiments may be practiced without these specific details. For example, well-known circuits, processes, algorithms, structures, and techniques have been shown without unnecessary detail in order to avoid obscuring the embodiments.

Furthermore, embodiments (including the receiver and transmitter designs) may be implemented by hardware, software, firmware, middleware, microcode, hardware description languages, or any combination thereof. When implemented in software, firmware, middleware or microcode, the program code or code segments to perform the necessary tasks may be stored in a machine readable medium such as a storage medium. Processors may perform the necessary tasks.

Having described several embodiments, it will be recognized by those of skill in the art that various modifications, alternative constructions, and equivalents may be used without departing from the spirit of the invention. For example, the above elements may merely be a component of a larger system, wherein other rules may take precedence over or otherwise modify the application of the invention. Also, a number of steps may be required before the above elements are considered. Accordingly, the above description should not be taken as limiting the scope of the invention, which is defined in the following claims.

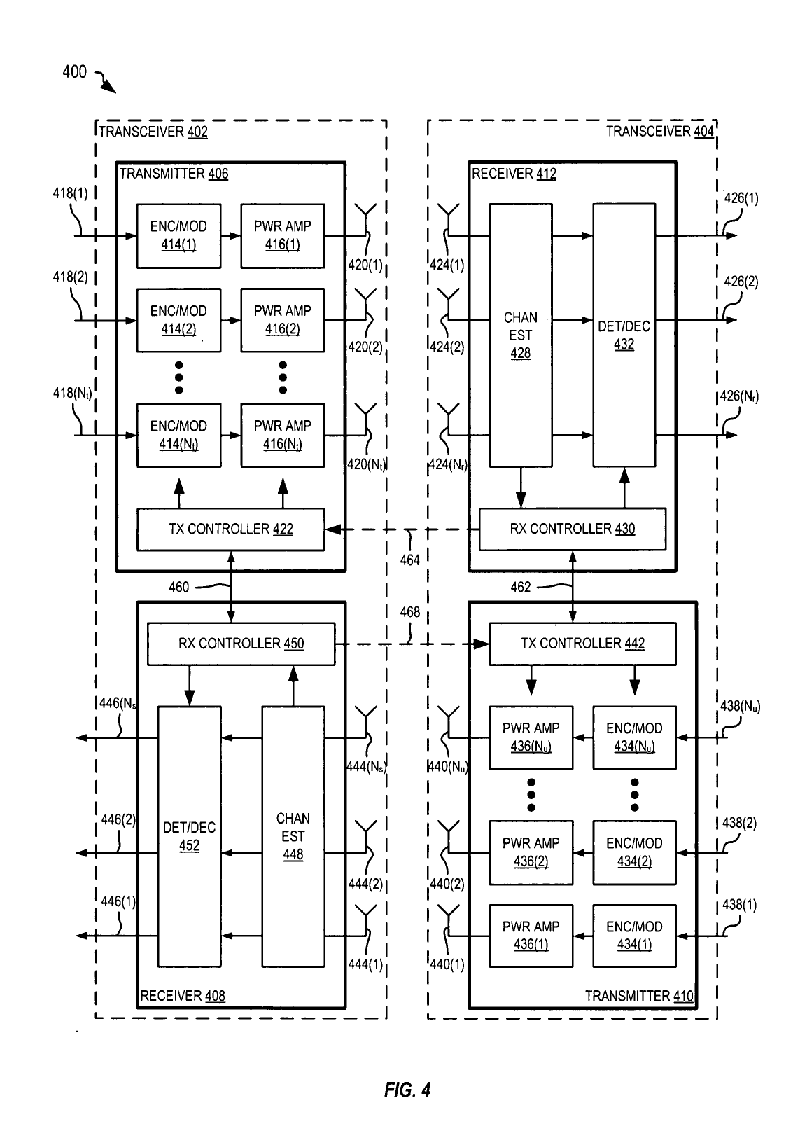

FIG. 4 shows one exemplary embodiment of a MIMO communication system 400 formed with two transceivers 402, 404 configured to provide bidirectional wireless communication. Transceivers 402 and 404 may be similar to one another. Transceiver 402 has a transmitter 406 and a receiver 408; transceiver 404 has a transmitter 410 and a receiver 412.

Transmitter 406 is shown with Nt transmit channels, each having an encoder/modulator 414, a power amplifier 416, an input 418 and an antenna 420. Encoder/modulator 414 is for example a variable rate encoder, and power amplifier 416 is for example a variable gain power amplifier. Transmitter 406 is also shown with a controller 422 that controls encoding rate and power of each transmit channel.

Receiver 412 is shown with Nr receive channels, each having an antenna 424 and an output 426. Signals from antennae 424 are evaluated by a channel estimator 428 to determine a status for each receive channel that allows a detector/decoder 432 to detect and decode each receive channel and output data for each receive channel on outputs 426. Output from channel estimator 428 are also input to a receive controller 430 that determines a decoding order for the receive channels.

Similarly, transmitter 410 is shown with Nu transmit channels, each having an encoder/modulator 434, a power amplifier 436, an input 438 and an antenna 440. Transmitter 410 is also shown with a transmit controller 442 that controls encoding rate and power of each transmit channel.

Receiver 408 is shown with Ns receive channels, each having an antenna 444 and an output 446. Signals from antennae 444 are evaluated by a channel estimator 448 to determine a status for each receive channel that allows a detector/decoder 452 to detect and decode each receive channel and output data for each receive channel on outputs 446. Output from channel estimator 448 is also input to a receive controller 450 that determines a decoding order for the receive channels.

Each controller 422, 430, 442 and 450 may comprise one or more microcontrollers and/or processors. In an alternate embodiment, controllers 418 and 450 may be implemented as a single processor and controllers 430 and 442 may be implemented as a single processor, without departing from the scope hereof.

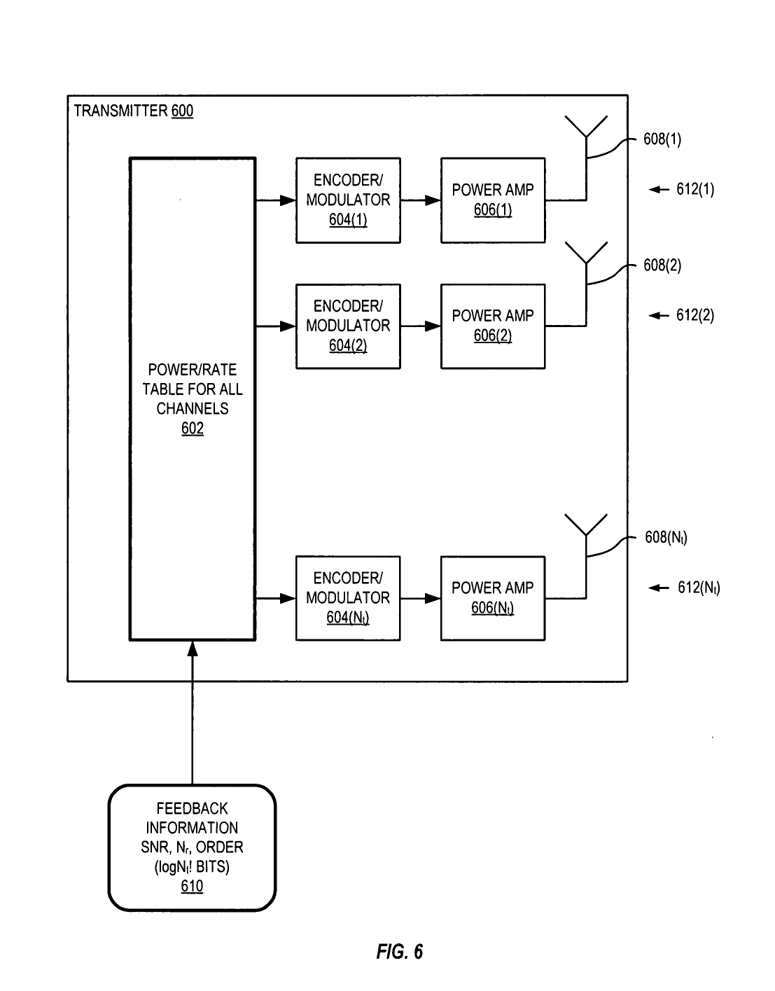

Transmit controller 422 and receive controller 450 communicate via a data path 460; transmit controller 442 and receive controller 430 communicate via a data path 462. Communication paths 460 and 462 provide a feedback path 464 from receiver 412 to transmitter 406 and provide a feedback path 468 from receiver controller 450 to transmitter controller 442. These feedback paths allow feedback information (see feedback information 610, FIG. 6) to be returned to a transmitter from a receiver.

Feedback information from receiver 412 is sent from receive controller 430 to transmit controller 442 via data path 462. Transmit controller 442 inserts the feedback information into a communication protocol transmitted from transmitter 410 to receiver 408. The feedback information is received by receive controller 450 and sent to transmit controller 422 via data path 460.

Similarly, feedback information from receiver 408 may be sent from receive controller 450 to transmit controller 422 via data path 460. Transmit controller 422 inserts the feedback information into a communication protocol transmitted from transmitter 406 to receiver 412. This feedback information is received by receive controller 430 and send to transmit controller 442 via data path 462.

This and other such feedback mechanisms between receivers and transmitters are well know in the art and may be implemented as permitted by the protocols and underlying hardware. Of note, these feedback mechanisms have a bandwidth that is typically one or more orders of magnitude less that the bandwidth of data carried by the protocol.

Data is formatted into frames for transmission within system 400. The use of frames is widely known and used in the art. Thus, the protocol used between transmitter and receiver permits the transmit rate and power of each channel to be evaluated and adjusted every few frames without interrupting the flow of data within the system.

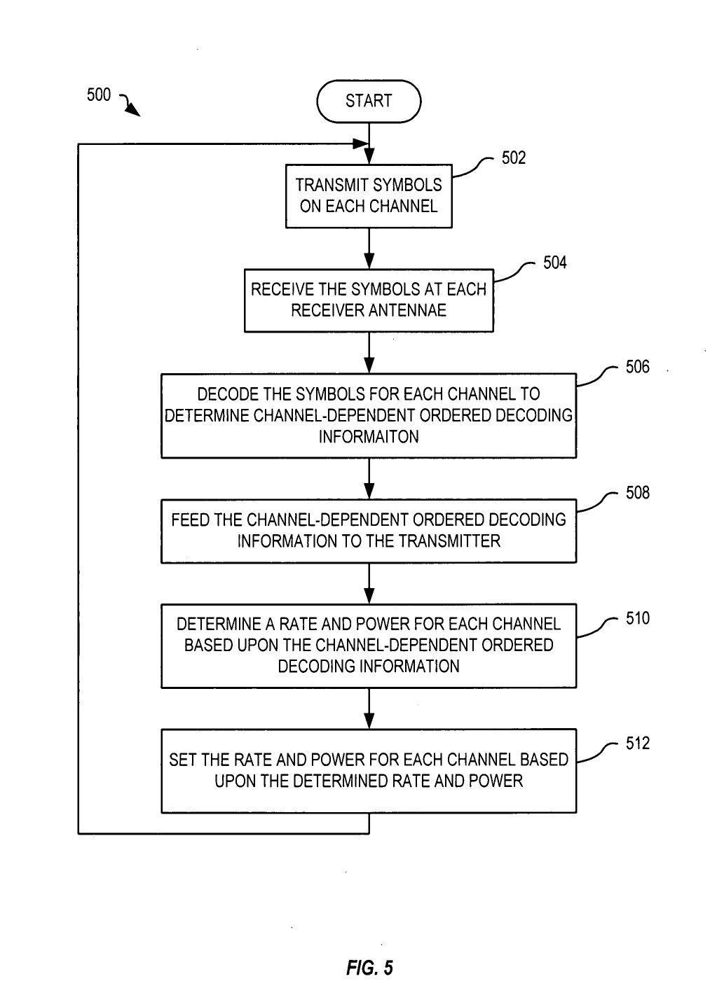

FIG. 5 is a flowchart illustrating one exemplary method 500 for controlling rate and power of data transmitted from a plurality of transmit channels of a transmitter based upon feedback information from a receiver of the data. Method 500 is for example implemented within various parts of system 400, FIG. 4. For example, steps 502 and 512 of method 500 are implemented, at least in part, within transmit controller 422 of transmitter 406. Step 504 may be implemented within antennae 424 of receiver 412. Step 506 may be implemented within channel estimator 428 and receive controller 430. Step 508 may be implemented, at least in part, by transmitter 410 and receiver 408, and step 510 may be implemented within transmit controller 422.

In step 502, method 500 transmits symbols on each channel of the transmitter. In one example of step 502, transmitter 406 transmits symbols from each of antennae 420. In step 504, method 500 receives the transmitted symbols at each antennae of the receiver. In one example of step 504, symbols transmitted from antennae 420 are received by antennae 424. In step 506, method 500 decodes and analyzes the symbols received by each channel to determine channel-dependent ordered decoding information. In one example of step 506, information from channel estimator 428 is analyzed by receive controller 430 to determine a signal to noise ratio (SNR) for all receive channels and uses the greedy ordering rate-tailored algorithms disclosed herein to determine a channel ordering.

In step 508, method 500 feeds the channel-dependent ordered decoding information to the transmitter. In one example of step 508, the determined SNR for each channel, the number of transmit channels Nₜ and the number of receive channels Nᵣ is sent from receive controller 430 to transmit controller 422 via data path 464, transmitter 410, and to receiver 408 via data path 460. In step 510, method 500 determines a rate and power for each channel based upon the channel-dependent ordered decoding information fed to the transmitter in step 508. In one example of step 510, transmit controller 422 utilizes a lookup table and the SNR, Nₜ and Nᵣ information fed back from receiver 412 to determine rate and power settings for each transmit channel of transmitter 406. In step 512, method 500 sets the rate and power for each transmit channel based upon the determined rate and power for each channel. In one example of step 512, transmit controller 422 sets the rate of encoder/modulators 414 and the power of power amplifiers 416 based upon the rates and powers determined from the lookup table.

Steps 502 through 512 may repeat periodically to control rate and power of the transmitter. In one example, steps 502-512 repeat every 5 ms to adjust the rate and power of each channel of transmitter 406 as the wireless environment changes.

FIG. 6 is a block diagram illustrating one exemplary transmitter 600 that uses a power/rate table 602 (i.e., a lookup table) to determine rate settings for encoder/modulators 604 and power settings for power amplifiers 606 for each of transmit channels 612(1)-612(Nₜ). Transmitter 600 may represent transmitters 406 and 410 of FIG. 4. Feedback information 610 is sent from a receiving receiver (e.g., receiver 412) and contains information that may be used to determine rate and power settings for each channel 612 using power rate table 601. Table 1 may represent part of power/rate table 602. Thus, based upon the SNR, number of receive channels Nr and the order information contained within feedback information 610, power/rate table 602 may be used to determine the rate and power settings for each transmit channel.

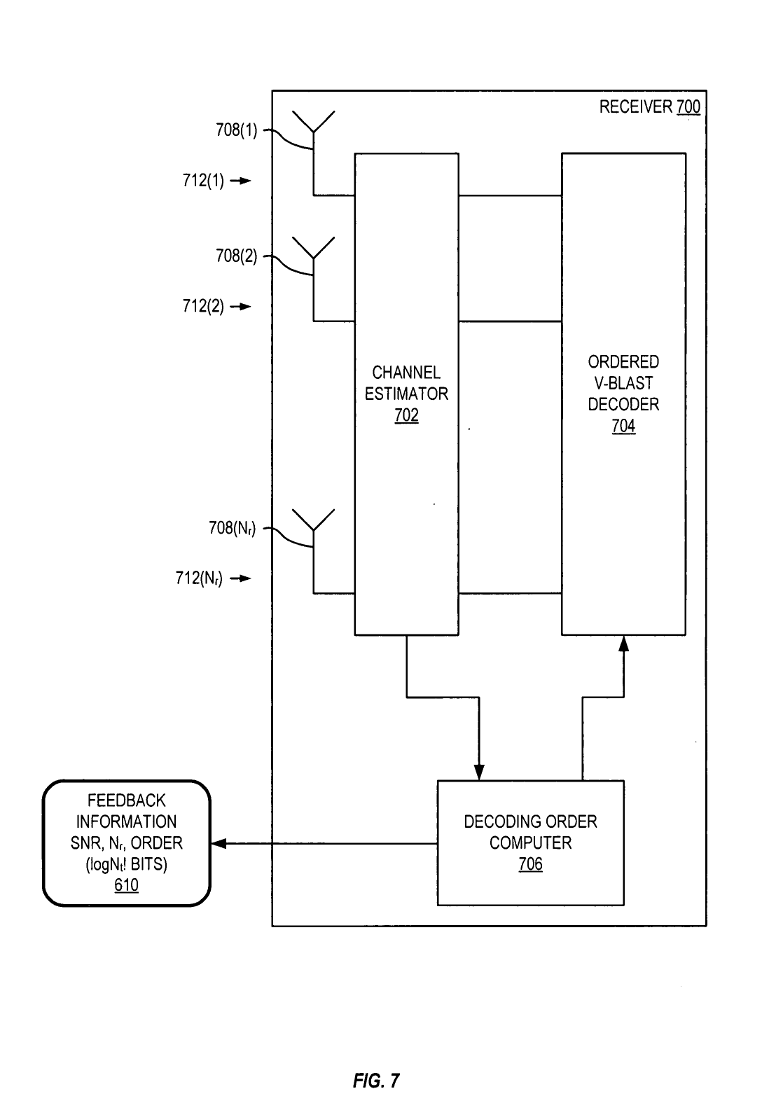

FIG. 7 shows one exemplary receiver 700 with channels 712(1)-712(Nᵣ), antennae 708(1)-708(Nᵣ), a channel estimator 702, an ordered V-BLAST decoder 704 and a decoding order computer 706 that implements a Greedy QR decomposition as shown in association with equation 19 and generates feedback information 610. Decoding order computer 706 also controls ordered V-BLAST decoder 704 to decode data from each receive channel 712. Of note, decoding order computer 706 may include information of power/rate table 602 to facilitate determination of feedback information 610.

Additional information may be included within feedback information 610 without departing from the scope hereof. For example, SNR values for each channel may be included within feedback information 610 to facilitate further improvements in performance of system 400.

What is claimed is:

1. A method for varying rates and powers for each of a plurality of transmit channels in a multiple input multiple output (MIMO) communication system, comprising:
transmitting symbols on each of the plurality of transmit channels from a transmitter;
receiving the symbols at each of a plurality of receive channels of a receiver;
decoding the symbols, for each of the plurality of receive channels, to determine channel-dependent ordered decoding information;
feeding the channel-dependent ordered decoding information to the transmitter;
determining, at the transmitter, a rate and a power for each of the plurality of transmit channels based upon the channel-dependent ordered decoding information; and
setting the rate and power for each of the plurality of transmit channel based upon the determined rate and power for each of the transmit channels.

2. The method of claim 1, wherein the step of decoding is based upon Bell Labs layers Space-Time (BLAST) detection/decoding.

3. The method of claim 1, wherein the step of decoding is based upon vertical Bell Labs layers Space-Time (V-BLAST) detection/decoding.

4. The method of claim 1, wherein the step of determining comprises looking up the rate and power for each of the transmit channels in a lookup table based upon the channel-dependent ordered decoding information.

5. The method of claim 1, wherein the channel-dependent ordered decoding information comprises a signal to noise ratio for all channels of the receiver, the number of receive channels and determined order information for the receive channels.

6. The method of claim 5, wherein the order information is based upon a Greedy QR decomposition.

7. The method of claim 1, wherein the steps of transmitting, receiving, decoding, feeding, determining and setting are repeated periodically to vary rates and powers for each of the plurality of channels.

8. A spatial multiplexing architecture (SMA) for multiple input multiple output (MIMO) communications, comprising:
a receiver having a receive controller and a plurality of receive channels, each channel comprising:
a channel estimator; and
a decoder;
a transmitter having a transmit controller, a power/rate table and a plurality of transmit channels, each channel comprising:
a variable rate encoder; and
a variable gain power amplifier;
the receive controller determining a signal to noise ratio (SNR) for the receive channels and channel-dependent ordered information based upon output from the channel estimator, the controller determining feedback information to include the SNR, a number of receive channels and the channel-dependent ordered information, the receive controller sending the feedback information to the transmitter controller, the transmitter controller determining, from the power/rate table, a rate and power setting for the variable rate encoder and the variable gain power amplifier of each of the transmit channels based upon the feedback information.

9. The SMA of claim 8, wherein the channel-dependent ordered information is based upon a Greedy QR decomposition.

10. The SMA of claim 8, wherein the power/rate table is located within the transmit controller.

11. The SMA of claim 8, wherein the feedback information and settings for the variable rate encoders and the variable gain amplifiers are determined periodically.

12. The SMA of claim 8, wherein the feedback information further comprises SNR values for each of the receive channels.
